(19) United States
(12) Patent Application Publication
(10) Pub. No.: US 2020/0020096 A1
(43) Pub. Date: Jan. 16, 2020

(54) Generalized Process for Categorizing and Analyzing Image Data

(71) Applicant: William Franz Lamberti, Fairfax, VA (US)

(72) Inventor: William Franz Lamberti, Fairfax, VA (US)

(21) Appl. No.: 16/032,936

(22) Filed: Jul. 11, 2018

(51) Int. Cl. G06T 7/00; G06T 1/00

(52) U.S. Cl. CPC G06T 7/0012; G06T 2207/30068; G06T 2207/20081; G06T 1/0007

(57) ABSTRACT

A general process for analyzing image data is presented. Many times, algorithms try to find partitions of an image and make conclusions based on these segmentations and exact locations within the larger image. However, the process described herein makes broader inferences about image data. The general process is described in detail, and then two examples of the process applied are explored in detail utilizing mammograms and a subset of the British Library's Online image database.

### 1. BACKGROUND

Many processes attempt to classify partitions of image for analysis. However, a more generalized and simple process for categorizing an image as a whole as containing an object or feature or belonging to a particular class is warranted. For example, a simpler process that states whether or not a image contains a stop sign or a microcalcification is worthwhile. The step of finding region of interests is a complicated step for analyses. A process which categorizes the entire image is still a worthwhile endeavor as there would still be many practical applications. For example, identifying which mammograms have malignant tumors is still very valuable, even if the user does not know the tumor's precise location.

### 2. SUMMARY

The process herein is as follows: data collection of a phenomena, image operators or data processing, data analysis and modeling, interpretation of the model, implementation of the analysis, and refinement, if needed. FIG. 1 shows a diagram of this process.

The process starts by observing some event that occurs in the world. This takes a variety of forms. For example, it could simply be the observation that trees tend to be green and clouds are not.

The second step is to collect data on this event. This can take a variety of forms. Continuing with the simple example, one can take digital pictures using a smartphone of a variety of clouds and trees.

The third step is to transform the data into a helpful format for analysis. This will be problem dependent. For the example provided, one might utilize only the green channel from the rgb image structure of the images as all the tree leaves are green. Perhaps using a mathematical transformation, such as principal component analysis or a Fourier transform, would ease the analysis. The image operators could be used in conjunction with mathematical ones, only one image operator, or only a mathematical transformation.

The fourth step is to model the data in an appropriate manner for the given problem that categorizes the entire image. Multiple models might be created and evaluated independently or jointly. An example of this might be building a model using linear discriminant analysis utilizing the image histograms of the green channel of the collected images of trees and clouds. In this case, only one model was built. If we wanted to compare it to another technique, one might compare it to a k-means clustering approach. One could then create a voting scheme to combine both model's together. It should be noted that the modeling technique is not limited to a particular field such as artificial intelligence or statistics. Any method from any field could be utilized.

The fifth part is to implement the model for solving needed problems in any appropriate field. This may require setting up a computer or machine where this model is a part of the system. For example, given the final model utilized for classifying trees and clouds, one might incorporate it in a website so that users can input their images of trees or clouds and check to see if the model classifies that input image correctly.

The last step is to refine the process as needed. This may take the form of adding more data or changing the modeling technique utilized. For instance, assume that the model does not predict clouds during sunset correctly. Thus, one might take more images of clouds during sunset, add them to the data, obtain their green channel, recompute the model using all the data, reinterpret the model, and then update the implementation as needed. Note that it is not required to collect more data. The refinement could skip this step and instead start at image operators or data processing or data analysis and modeling.

Additional considerations should be mentioned for subject matter experts. This valuable information can potentially provide input at any stage of the process. For example, a subject matter expert might have the insight that not all trees have green leaves, and discuss with modelers what range of colors are typical for trees to be analyzed for the problem at hand.

### 3. BRIEF DESCRIPTION OF DRAWINGS

FIG. 1 shows the general process outlined in a diagram format.

FIG. 2 shows an example of a fatty breast on the left and a dense breast on the right.

FIG. 3 was the ROC curve for the first method on the mammogram data.

FIG. 4 was the ROC curve for the second modeling technique on the mammogram data.

FIG. 5 provides examples of a portrait, flora, fauna, and architecture photo each noted by 1, 2, 3, and 4, respectively.

FIG. 6 shows the ROC for the k-fold CV utilizing the first modeling technique on the British Library data.

FIG. 7 shows the ROC for the k-fold CV model using the second technique on the British Library data.

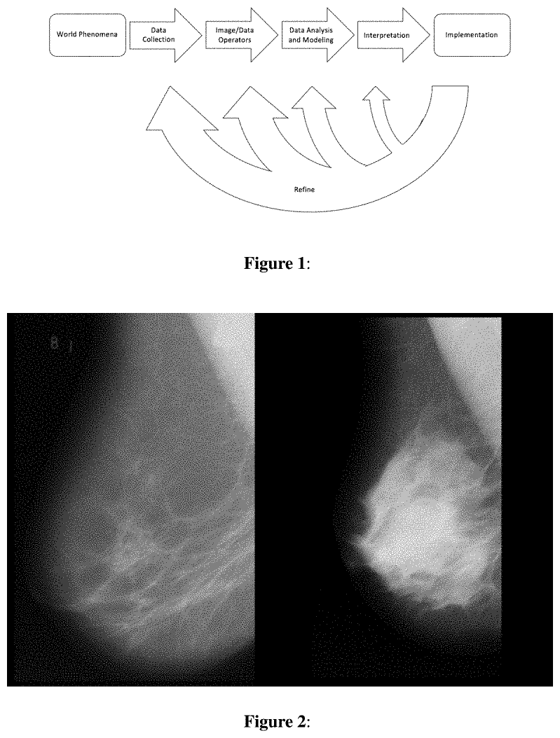

### 4. DETAILED DESCRIPTION

In this patent, a generalized process for analyzing data is presented. This encompasses a variety of different kinds of classification situations as shown in the provided examples. In this section, two examples will be discussed at length utilizing this process described. The first is regarding mammogram classification, and the second discusses portrait classification.

### 4.1 Mammogram Example

### 4.1.1 World Phenomena

The first step for acquiring mammogram data is to place each patient's breasts individually on the X-ray plate. Then another plate is used to compress the breast to help spread out the tissues. This is done so that radiation use is minimized and that the visualization of the X-ray image is optimized. There are many benefits of mammograms: they are a relatively inexpensive and noninvasive data collection method; modern X-ray source and detection technology minimizes radiation doses to the patient; and the technique is a universally accepted method for screening and diagnosis. However, despite decades of technique development, interpretation of mammograms, both Computer Aided Detection, or CAD, based and manual, poses challenges. For example, tissue type affects the nature of the image data and complicates interpretation and analysis. Fatty tissue results in image data that is more uniform and results in higher values for sensitivity and specificity. However, denser tissue results in greater X-ray attenuation, resulting in lower values for sensitivity and specificity. In short, reliable interpretation of 2D mammograms continues to pose challenges.

Manual analysis of mammogram image data occurs when radiologists will visually try to detect any abnormal features without the use of computer algorithms. They will look for large concentrations of white because features such as tumors, that are not fatty, will be displayed as white dense areas on the mammograms. This corresponds to greater X-ray attenuation. Scar tissue from previous surgery would also appear bright white, but should not be considered as an indicator of a malignancy. Thus, while features such as shape, density, and central masses are helpful indicators, it is often desirable that two radiologists independently analyze the images and reach consensus.

CAD is used by radiologists with the hope of decreasing misclassifications. The recommended procedure is to have a single radiologist perform a review as normal. Then, a second review is performed by CAD. It identifies abnormalities for subsequent review by the radiologist, who decides whether or not the abnormality warrants further investigation. CAD is typically more capable of detecting ductal carcinoma in situ, or stage 0 cancer. CAD has been found to identify more potential cases of cancer, and therefore saved more lives. However, if the patient is misclassified as having cancer when he or she does not, this has the patient undergo several more tests and procedures. Some of these patients undergo invasive tests such as biopsy. The overall experience puts additional economic, emotional, and physiological strain on the patient. Furthermore, some tests are not covered by health insurance or are too expensive to cover as an out-of-pocket expense. Thus, when CAD use resulted in a false positive, it can cause unneeded costs on the patient.

### 4.1.2 Data Collection

The data analyzed was obtained from the Mammographic Image Analysis Society (MIAS) database. The images were originally film photographs but were scanned and converted to a digital format. There are a total of 322 mammograms, or 161 patients, in the data set. There are 61 breasts with benign tumors, 51 breasts with malignant tumors, and 209 breasts that are normal. In summary, 108 patients have some type of tumor present, while 53 do not. FIG. 2 shows two examples of the mammograms.

### 4.1.3 Image/Data Operators

There are a wide variety of different options on transforming the mammograms into more helpful formats. The use of a specific operator may change given the desired goal of the analysis. Furthermore, a specific operator may be applied to some but not all of the images. In this case, a variety of different techniques were utilized and compared during the process.

### 4.1.4 Data Analysis and Modeling

The goal of this example is to correctly classify those mammograms with malignant tumors and those who do not have malignant tumors. Appropriate features from the images were selected for the analysis. If needed, additional variables could be included at a future time to further improve the model.

Sometimes, the variables must be further refined. For example, some variables could be discretized using Paritioning Around Medoid (PAM), a more robust alternative to k-means clustering. The optimal number of clusters was determined using the optimum average silhouette width. The optimum silhouette width criterion for an observation is as follows

$$s ( i ) = \frac{b ( i ) - a ( i )}{max \{ a ( i ) , b ( i ) \}} \qquad ( 1 )$$

where
1. i=any given observation observed in the data
2. A=the cluster to which i has been assigned
3. a(i)=the average dissimilarity of i to all other members of A
4. b(i)=the minimum average dissimilarity of i to all other clusters it does not belong to

(1) can be rewritten as follows as

$$s ( i ) = \{ \begin{matrix}1 - \frac{a ( i )}{b ( i )} & if a ( i ) < b ( i ) \\ 0 & if a ( i ) = b ( i ) \\ \frac{b ( i )}{a ( i )} - 1 & if a ( i ) > b ( i )\end{matrix} \qquad ( 2 )$$

Thus, a value of s(i) close to 1 indicates that the given observation is well categorized. Conversely, a value of s(i) close to −1 indicates that the given observation is not well categorized. Thus, for a given cluster, the average of all the s(i)'s in that cluster indicates if the cluster groups the observations well. This average value is called the optimum average silhouette width.

After the variables were refined, a model was built to determine if the observation has malignant cancer or not. Once the 322 observations were split into training and testing data sets respectively, cross validation, CV, was performed.

### 4.1.5 Interpretation

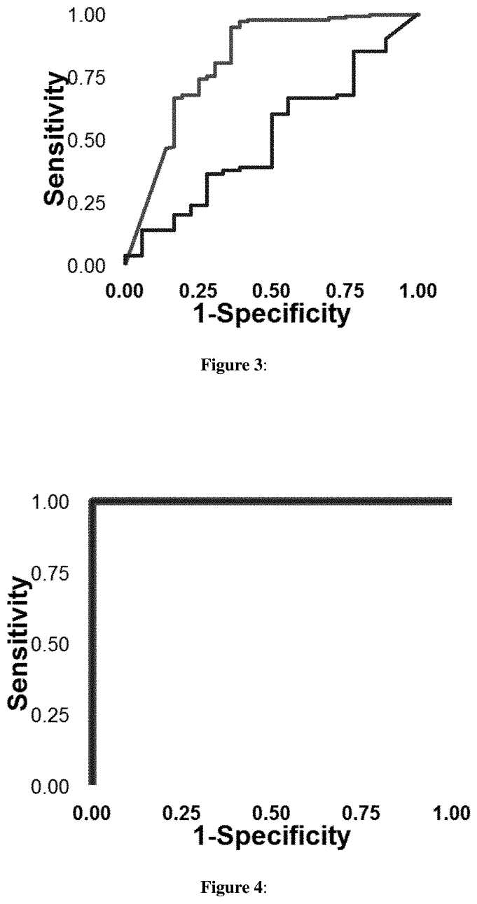

Table 1 shows summary statistics on the classification error loss function rate for the CV process on the training data. The quality of the CV utilizing the first method was analyzed using ROC curves as shown in FIG. 3. The red (or light gray when using grayscale) line was associated with the training data, and the blue (or dark gray) line was associated with the testing data. Sensitivity can be interpreted as the correct classification rate for those mammograms that do not have malignant cancer. Specificity can be interpreted as the correct classification rate for those mammograms that have malignant cancer. The area under the curve (AUC) for the training data set was 0.814. The AUC for the testing data set was about 0.507. It is desired to keep the classification rate for those non-malignant observations above 0.50. Note that sensitivity is the true non-malignant classification rate, and that specificity is the true malignant classification rate. Thusly, the optimum value was determined to be 0.75 for both cases using the training data, indicated by the red (or light gray) line. While this model does well for the training data, the model does not perform well on the testing data represented by the blue line. The model is only able to correctly classify about 0.50 of those cases with malignant cancer and about 0.60 of the other case at a different cutoff threshold value.

TABLE 1
Summary classification error loss function rate for the training data after the CV step for the 1st model.
Note the range was about 0.22. This large range suggests that the models were not homogeneous.

| Min | 1st Quantile | Median | Mean | 3rd Quantile | Max |
|---|---|---|---|---|---|
| 0.09091 | 0.11360 | 0.21740 | 0.20020 | 0.26090 | 0.31820 |

The ROC curve for the second model on the data is shown in FIG. 4. The red (or light gray) line was associated with the training data, and the blue (or dark gray) line was associated with the testing data. Sensitivity and specificity have the same definitions as defined previously. Note that the testing and training data sets used in this model were the same as those used in first modeling technique. The AUC for both the testing and training data sets for this modeling technique was 1. Note that the classification rate for both cases was 1.00 on the testing and training data sets. Thus, the first choice for a modeling tool was unable to perform as well as the second one. In this case, one would prefer the second modeling technique.

### 4.1.6 Implementation

The implementation of this process would involve the following: the creation of proprietary software that works alongside a variety of different mammogram machines, the installation of the software on these machines, the appropriate training of radiologist's on the interpretation of the algorithm's prediction, and then radiologist's utilizing the algorithm to aid making diagnoses.

### 4.2 Portrait Classification Example

### 4.2.1 World Phenomena

There are other methods that utilize a variety of features of images of faces alongside statistical or machine learning algorithms. In short, a variety of different techniques have been used for different types of problems. They range in complexity, interpretability, and ease of use. The specific problem to solve here is to discriminate portraits against other kinds of images.

### 4.2.2 Data Collection

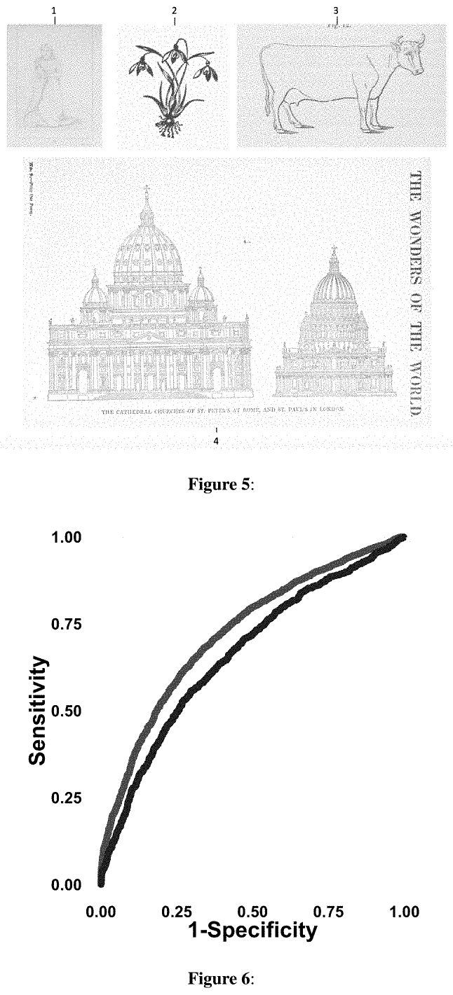

The data utilized in this analysis came from the British Library online Flikr database. While the total data set could not be utilized, the entirety of their portraits, flora, fauna, and architecture pictures were utilized. Each collection had 4581, 860, 2228, and 1995 pictures respectively for a total of 9664 photos analyzed. These photos generally consisted of hand drawn photos, however, there were some photographs. Thus, the type of image analyzed is not consistent. An example of each class is provided in FIG. 5. Note that some are originally in color, while others were black and white on an off white sheet of paper. Some images also had text written on them, as shown in the architecture example. Thus, the type of image even within the categories was not consistent. This would add noise to our data and may skew results.

### 4.2.3 Image/Data Operators

As stated previously, a variety of different techniques can be utilized to analyzed these images. In this example, a few simpler transformations or operators were deployed.

### 4.2.4 Data Analysis and Modeling

A variety of different exploratory techniques and visualizations were utilized during the analysis. It was determined that some variable reduction techniques would be helpful during the model building process.

After the number of variables was reduced on a training data, different models were built utilizing CV and compared utilizing both testing and validation data sets. FIG. 6 shows the ROC curve for utilizing the first modeling technique. Note that red (or light gray) line corresponds to the testing set and the blue (or dark gray) line corresponds to the validation set. The AUC of the testing and the validation set was, respectively, 0.7233 and 0.662. Thus, very little information was lost between the testing and the validation data. This means that the final model predicts similarly on data trained to make the model at any point, and data not trained with the model. Sensitivity and specificity have the same definitions described previously in this section.

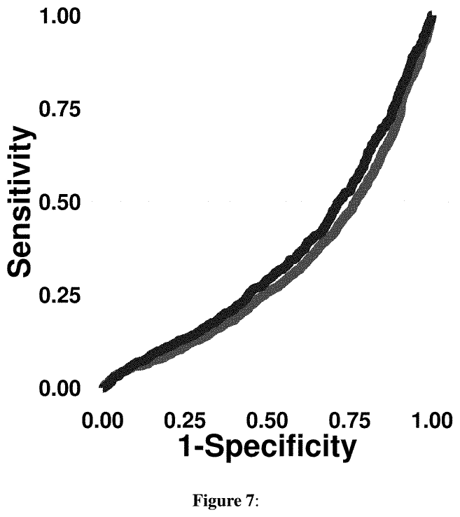

FIG. 7 shows the ROC curve for a second modeling technique. Note that red (or light gray) line corresponds to the testing and the blue (or dark gray) line corresponds to the validation set. Note that for both the testing and the validation set, we have that the AUC is substantially less than 0.50. Thus, this model is far less superior in comparison to the first model shown previously. Sensitivity corresponds to those correctly classified portrait images, and specificity corresponds to those other correctly classified images.

### 4.2.5 Interpretation

As the ROC of the first model has both of the lines closer together alongside having higher AUC values, this is the superior model to utilize. The first model was able to achieve about 62.5% overall classification.

### 4.2.6 Implementation

The implementation of this process could involve the following: the creation of proprietary software that could be utilized in a smartphone application or website, the creation of an instructional video for users to utilize there own pictures to see if the model predicts correctly on those images, the execution of the product, the automatic saving of uploaded images, and then the recalibration and refinement of the model with additional user inputted data and images.

### 4.3 Conclusion

In this patent, a generalized process for analyzing data is presented. This encompasses a variety of different kinds of classification situations as shown in the provided examples. Two examples concerning mammograms and portraits were explored. These presented approaches can be expanded to other cases that are more similar such as testicular cancer x-ray image, or more distant cases such as infrared images or sonar images of the ocean's floor. Thusly, the applicability and range of possibilities is only limited by one's imagination.

What is claimed is

1. A method for the collection, image or data operations, data analysis and modeling, interpretation, and implementation of image data with or without outside data where refinement is utilized as needed.

2. The method of claim 1, wherein the collection is done by an image capturing or creation device or tool.

3. The method of claim 1, wherein the collection is stored or saved as any image file type.

4. The method of claim 1, wherein the collection of the images was performed using any combination of one or more of sampling schemes or weightings, a convenient sample, or a biased sample.

5. The method of claim 1, wherein the collection of the images was performed in a clinical trial.

6. The method of claim 1, wherein the preprocessing includes any combination of image or mathematical operators or transformations of the images.

7. The method of claim 1, wherein the partitioning of the images utilizes any combination of testing, training and validation sets.

8. The method of claim 1, wherein the partitioning of the images utilizes any form of cross-validation.

9. The method of claim 1, wherein the modeling of the images utilizes any field's, discipline's, or philosophy's techniques or tools for modeling.

10. The method of claim 1, wherein the interpretation of the images resulted from any combination of the following: performing the modeling alone to infer about the data, performing the modeling and subject area expertise to infer about the data, performing the subject area expertise alone to infer about the data.

11. The method of claim 1, wherein the interpretation of the images includes using outside information or data.

12. The method of claim 1 applied to classifying mammogram images (or any other image of tissue) as a whole, whether they be 3D or 2D images, alongside one or multiple views of the tissue.
